(19) United States
(12) Patent Application Publication
(10) Pub. No.: US 2021/0244012 A1
(43) Pub. Date: Aug. 12, 2021

(54) ANIMAL TRAP

(71) Applicant: Campbell-Frazier, LLC, Portland, OR (US)

(72) Inventor: Donald S. Frazier, Portland, OR (US)

(73) Assignee: Campbell-Frazier, LLC, Portland, OR (US)

(21) Appl. No.: 17/141,805

(22) Filed: Jan. 5, 2021

Related U.S. Application Data
(60) Provisional application No. 62/972,549, filed on Feb. 10, 2020.

(51) Int. Cl. A01M 23/30; A01M 23/24

(52) U.S. Cl. CPC A01M 23/30; A01M 23/36; A01M 23/245

(57) ABSTRACT

In one embodiment, an animal trap comprises an outer housing configured as a hollow shell with one or more side openings in a lower end portion of the housing; a moveable plunger member; and an inner cartridge removably coupled to an interior of the housing. The cartridge supports therein: the plunger member configured to move axially between a raised position and a lowered position relative to the housing and the cartridge; and a retaining mechanism configured to selectively retain the plunger member in the raised position.

### CROSS REFERENCE TO RELATED APPLICATION

This application claims the benefit of U.S. Provisional Patent Application No. 62/972,549, filed Feb. 10, 2020, which is incorporated herein by reference in its entirety.

### FIELD

The present invention relates generally to an apparatus for trapping small animals, such as moles.

### BACKGROUND

Various devices are known for capturing and killing rodents and other animals, such as moles, in subterranean environments, such as tunnels located below the soil surface. Most commercially available animal traps are mechanical devices that are unreliable, not very effective, and sometimes difficult to use. Accordingly, for at least these reasons, there is a need for new and improved animal traps for capturing and/or killing animals in subterranean environments.

### SUMMARY

In one representative embodiment, an animal trap comprises an outer housing configured as a hollow shell with one or more side openings in a lower end portion of the housing; a moveable plunger member; and an inner cartridge removably coupled to an interior of the housing, the cartridge supporting therein: the plunger member configured to move axially between a raised position and a lowered position relative to the housing and the cartridge; and a retaining mechanism configured to selectively retain the plunger member in the raised position.

In some embodiments, the plunger member comprises a shaft portion with a biasing element configured to urge the plunger member into the lowered position and a lower end portion configured to incapacitate or kill an animal within an internal cavity of the lower end portion of the housing.

In some embodiments, the retaining mechanism comprises a slideable piston moveable between a first position and a second position. In the first position the piston engages the plunger members and holds it in the raised position and in the second position the piston is removed from engagement with the plunger member to allow the plunger member to move to the lowered position.

In some embodiments, the retaining mechanism further comprises a mechanical actuator comprising a trip plate disposed in the lower end portion of the housing and a retaining rod coupled to the trip plate and configured to engage the piston and hold the piston in the first position. The trip plate is configured to move the retaining rod out of engagement with the piston in response to pressure against the trip plate.

In some embodiments, the retaining mechanism further comprises a mechanical actuator comprising a trip plate disposed in the lower end portion of the housing and a rod coupled to the trip plate and coupled to the piston via a cam. The trip plate is configured to move the rod, which in turn moves the cam. Movement of the cam allows the piston to move from the first position to the second position.

In some embodiments, the piston is a first piston and the retaining mechanism further comprises an electromechanical actuator comprising a solenoid and a moveable, second piston that is configured to engage with the first piston and hold the first piston in the first position, the solenoid coupled to the second piston and configured to actuate the second piston to disengage from the first piston such that the first piston moves to the second position.

In some embodiments, the animal trap further comprises a motion detector in electronic communication with the solenoid and configured to detect when an animal has entered the lower end portion of the housing and then send an electronic signal to the solenoid to energize the solenoid and actuate the plunger member into the lowered position.

In some embodiments, the plunger member comprises a handle portion that is configured to be disposed exterior to the outer housing when the plunger member is in the raised position.

In some embodiments, the animal trap further comprises a retractable or removable handle mechanism configured to engage the plunger member and permit a user to move the plunger member from the lowered position to the raised position.

In some embodiments, the cartridge comprises sidewalls extending between an upper support and a lower support of the cartridge, the upper and lower supports each including a central aperture configured to receive a shaft portion of the plunger therethrough.

In another representative embodiment, an animal trap comprises a housing comprising one or more side openings in a lower end portion thereof; a moveable plunger member disposed at least partially within the housing and configured to move between a raised position and a lowered position relative to the housing; a biasing element configured to resiliently urge the plunger member to the lowered position; a retaining mechanism configured to selectively retain the plunger member in the raised position against a biasing force of the biasing element; and a motion detector inside the housing and operatively connected to the retaining mechanism, wherein the motion detector is configured to detect the presence of an animal within the lower end portion of the housing and actuate the retaining mechanism to release the plunger member, thereby allowing the plunger member to move from the raised position to the lowered position under the biasing force.

In some embodiments, the animal trap further comprises one or more light sources in the housing.

In some embodiments, the housing comprises a tubular body and the animal trap further comprises an inner cartridge removably coupled to the housing, where the retaining mechanism and plunger member are supported within the cartridge.

In some embodiments, the cartridge comprises one or more stabilizers configured to support the plunger member for movement within the cartridge and the housing.

In some embodiments, the retaining mechanism comprises a moveable piston that is moveable between a first position and a second position. When the piston is in the first position, the piston blocks the plunger member from moving to the lowered position, and when the piston is in the second position, the piston is removed from blocking the plunger member from moving to the lowered position.

In some embodiments, a lower end portion of the plunger member comprises a base and a plurality of claws pivotably connected to the base.

In another representative embodiment, an animal trap comprises: a housing comprising one or more side openings in a lower end portion thereof; a moveable plunger member disposed at least partially within the housing and configured to move between a raised position and a lowered position relative to the housing; one or more light sources disposed in the housing; and a motion detector inside the housing. The motion detector is configured to detect the presence of an animal within the lower end portion of the housing and cause the plunger member to move from the raised position to the lowered position when an animal is detected within the lower end portion of the housing.

In some embodiments, the animal trap further comprises a biasing element configured to resiliently urge the plunger member to the lowered position and a retaining mechanism configured to selectively retain the plunger member in the raised position against a biasing force of the biasing element.

In some embodiments, the retaining mechanism comprises a moveable piston that is movable between a first position and a second position. When the piston is in the first position, the piston blocks the plunger member from moving to the lowered position, and when the piston is in the second position, the piston is removed from blocking the plunger member from moving to the lowered position.

In some embodiments, the animal trap further comprises one or more stabilizers mounted within the housing and configured to support the plunger member for movement within the housing.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view of an animal trap, according to one embodiment.

FIG. 2 is perspective view of the animal trap of FIG. 1 shown in an open position.

FIG. 3 is a perspective view similar to FIG. 2 showing a plunger member of the animal trap in a raised position.

FIG. 4 is a side elevation view of the inside of an animal trap similar to the animal trap of FIG. 1.

FIG. 5 shows an alternative configuration of the engagement between a plunger member and a release mechanism for the animal trap of FIG. 4.

FIG. 6 shows the lower end portion of a plunger member for the animal trap of FIG. 4, according to another embodiment.

FIG. 7 shows the lower end portion of a plunger member for the animal trap of FIG. 4, according to another embodiment.

FIG. 8 is a cross-sectional, side view of an animal trap, according to another embodiment, where a plunger member of the animal trap is actuated by an electromechanical actuator.

FIG. 9 is a cross-sectional, side view of the inside of an animal trap, according to another embodiment, where a plunger member of the animal trap is actuated by a mechanical actuator.

FIG. 10 is a cross-sectional, side view of a portion of an inside of the animal trap of FIG. 9, including a mechanical actuator according to another embodiment.

FIG. 11 is a perspective view of an inner cartridge for an animal trap, such as one of the animal traps of FIG. 8 or 9, according to an embodiment.

FIG. 12 is a perspective view of a plunger member for an animal trap, according to an embodiment.

FIG. 13 is a perspective view of a plunger member for an animal trap which includes a retractable handle mechanism, according to an embodiment.

FIG. 14 is a perspective view of an outer housing of an animal trap, such as one of the animal traps of FIG. 8 or 9, according to an embodiment.

### DETAILED DESCRIPTION

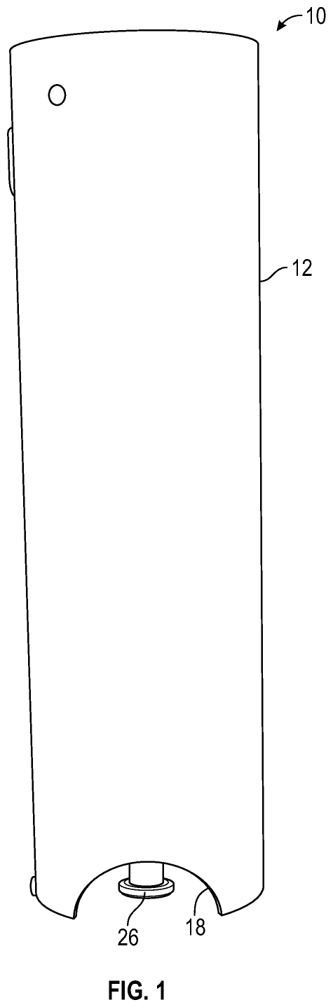

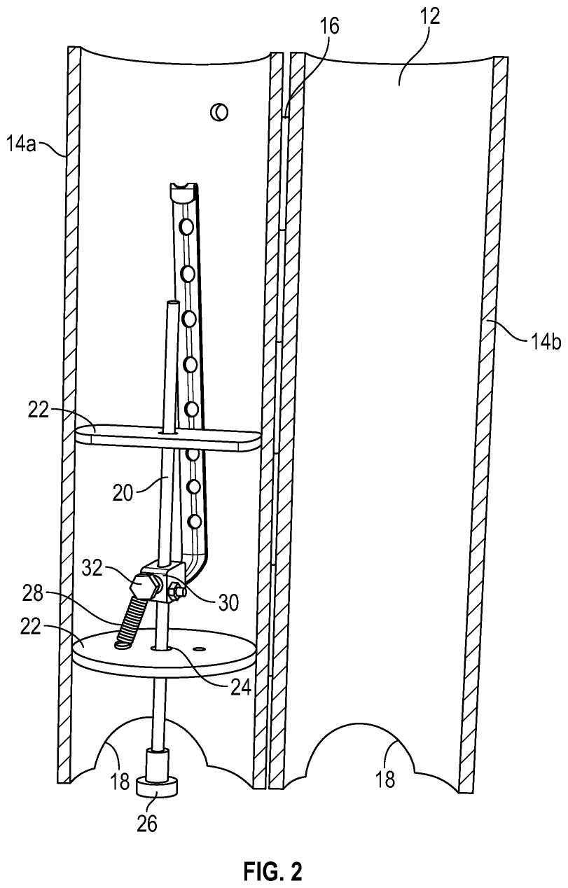

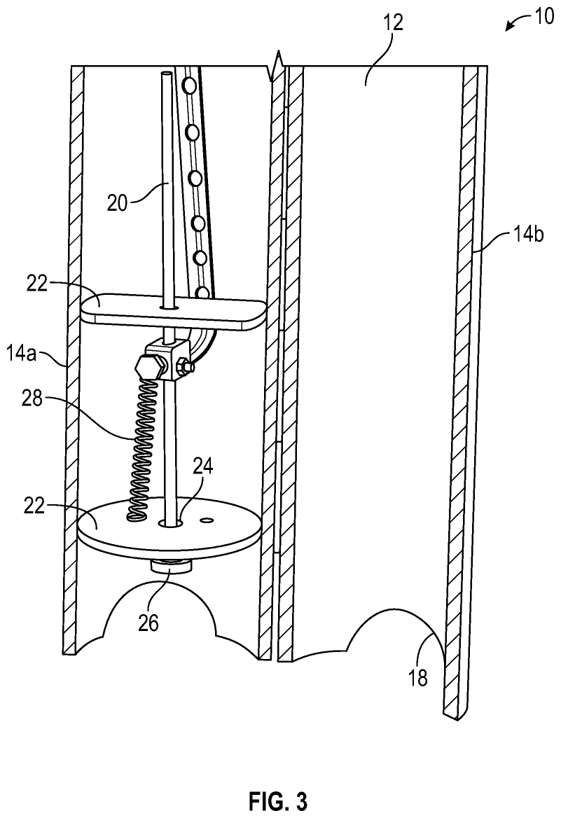

FIGS. 1-3 show an animal trap 10, according to one embodiment. The trap 10 is particularly suited for trapping small animals, such as moles, rats, mice, gophers, groundhogs, etc., in a subterranean environment. The trap 10 in the illustrated embodiment comprises a housing (e.g., outer housing) 12, which can comprise first and second housing portions 14a, 14b (FIGS. 2 and 3), which can be moved between a closed position for use (FIG. 1) and an open position for cleaning and/or retrieving an animal caught in the trap (FIGS. 2 and 3).

The housing portions 14a, 14b can be pivotably connected to each other, such as by a hinge 16 that is connected to two adjacent longitudinal side edges of the housing portions. The hinge 16 allows the housing portions 14a, 14b to pivot relative to each between the open and closed positions. One or both of the housing portions 14a, 14b can include a side opening 18 along a lower end portion thereof to permit access to the interior of the housing by an animal.

The housing 12 can be formed from any of various materials, including any of various polymers, metals, composites, and/or combinations thereof. In one specific implementation, the housing 12 is formed from plastic pipe, such as PVC pipe, that is cut in half lengthwise to form the housing portions 14a, 14b

Mounted inside the housing is a plunger member 20 that can move upwardly and downwardly within the housing (e.g., relative to the ground surface into which the trap 10 is positioned) and one or more stabilizers 22 that center and support the plunger member 20 for vertical movement within the housing (FIGS. 2 and 3). The stabilizers 22 can also be referred to as guides or guide members. The stabilizers 22 can be secured to the inner surface of one of the housing portions (e.g., the first housing portion 14a) with an adhesive, fasteners (e.g., screws), welding, or various other attachment means. Each stabilizer 22 can include a central opening 24 through which the plunger member 20 extends (FIGS. 2 and 3).

The plunger member 20 can include an enlarged lower end portion 26 configured to incapacitate or kill an animal that enters the housing 12. In the illustrated embodiment, the lower end portion 26 is in the form of a disc, although other configurations can be used, as further described below.

The stabilizers 22 desirably are made of a transparent material (e.g., a transparent plastic) that allows signals to and from a motion detector 44 (described below) to be transmitted along the length of the housing 12. Alternatively, the stabilizers can comprise an open framework, such as mesh or grid having openings that allow signals to and from the motion detector to pass through the stabilizers.

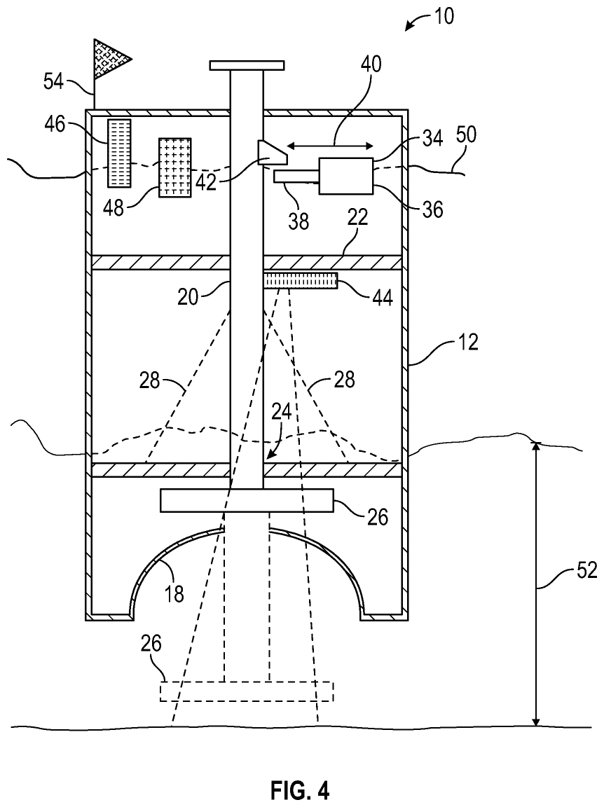

Referring also to FIGS. 2 and 3, the plunger member 20 is moveable relative to the housing 12 between a first or lowered position (FIG. 2) and a second or raised position (FIG. 3). In the raised position (FIG. 3), the lower end portion 26 of the plunger member 20 desirably is above the side openings 18 in the housing portions 14a, 14b, or at least high enough to allow an animal to enter the housing 12 through a side opening 18 with minimal or no restriction. In some embodiments (see FIG. 4, as described further below), when in the raised position, the upper end portion of the plunger member 20 can extend above the top of the housing 12 and can include a handle portion for grasping by a user. In the lowered position (FIG. 2), the lower end portion 26 of the plunger member 20 desirably extends below the side openings 18 (e.g., below a peak or upper edge of the side openings) and can contact an animal that has entered the housing 12. Depending on the particular configuration of the lower end portion 26, the lower end portion can incapacitate, kill, or trap the animal without harming it.

The plunger member 20 can be biased toward the lowered position by one or more biasing elements. In the illustrated embodiment, the biasing element comprises a helical spring 28. As shown in FIGS. 2 and 3, the spring 28 can be an extension spring and one end of the spring 28 can be fixedly secured to one of the stabilizers 22 and the other end of the spring can be fixedly secured to the plunger member 20. As such, when the plunger member 20 is raised to the raised position (FIG. 3), the spring 28 can expand and exert a biasing force on the plunger member 20. A retaining mechanism can be used to retain the plunger member 20 in the raised position against the bias of the spring 28 until an animal entering the housing triggers the plunger member, as described in detail below. When released from the raised position, the biasing force of the spring 28 causes the plunger member 20 to move from the raised position (FIG. 3) to the lowered position (FIG. 2).

The spring 28 can be secured to the plunger member and the stabilizer 22 using any of various techniques or mechanisms. In the illustrated embodiment, a bracket 30 is mounted on the plunger member 20 and held against the plunger member by a set screw 32. A looped upper end of the spring 28 can be disposed on the screw 32, which holds that end of the spring at a fixed position relative to the plunger member. The lower end of the spring 28 can be fixed to the lower stabilizer 22, such as with an adhesive or a mechanical fastener.

It should be understood that various other types of biasing elements can be implemented in the trap 10 to bias the plunger member 20 to the lowered position. For example, in alternative embodiments, the plunger member 20 can be biased by a compression spring, which can be disposed co-axially over the plunger member between the upper and lower stabilizers 22. In other embodiments, the biasing element can comprise an elastomeric member, such as an elastic band, which can be connected between the plunger member 20 and a stabilizer 22 in the same manner as spring 28 shown in FIGS. 2 and 3. Further, one end of the biasing element (whether a spring or elastomeric member) can be connected to an internal surface the housing or another component that is fixed relative to the inside surface of the housing. FIG. 4 is similar to FIGS. 2 and 3, except that two extension springs 28 are used to bias the plunger member 20.

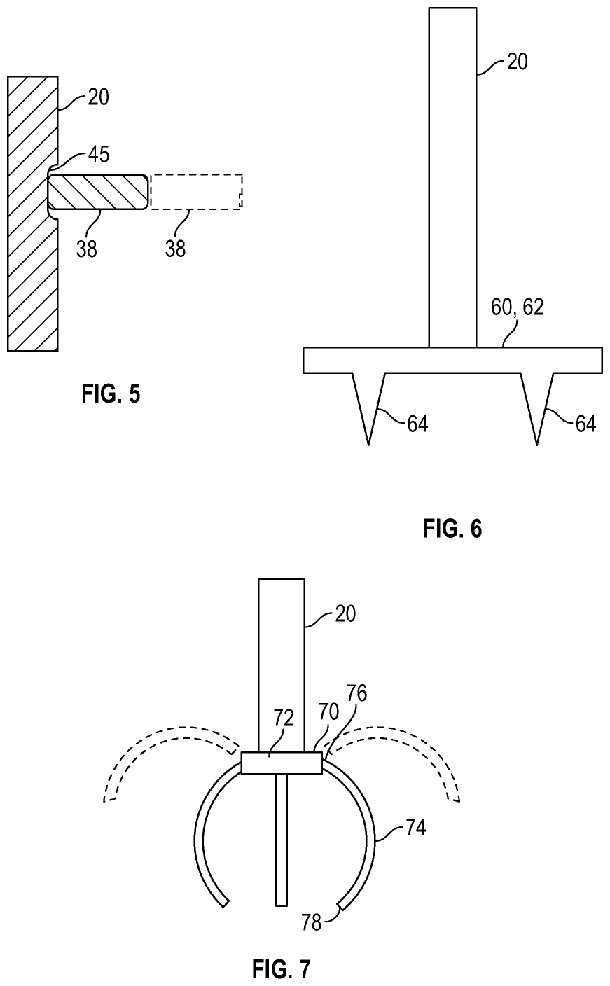

Referring to FIG. 4, the trap 10 can include a retaining mechanism 34 configured to selectively retain the plunger member 20 in the raised position. The retaining mechanism 34 in one implantation includes a housing 36 and a moveable piston 38. The housing 36 can be fixed to the inner surface of the housing 12. The piston 38 is moveable between an extended position (shown in solid lines) and a retracted position (shown in dashed lines in FIG. 5) in the directions indicated by double-headed arrow 40. In the extended position, the piston 38 engages the plunger member 20, such as a lateral projection 42 of the plunger member, to retain the plunger member 20 in the raised position against the bias of the spring(s) 28. When moved to the retracted position, the piston 38 does not block or engage the projection 42, and thereby allows the plunger member 20 to move to the lowered position under the force of the spring 28.

FIG. 5 shows an alternative embodiment in which the plunger member 20 comprises a notch 45 and the piston 38 extends into and engages the notch 45 when the piston is in the extended position. When moved to the retracted position (shown by dashed lines), the piston 38 is removed from the notch 45 and no longer blocks movement of the plunger member 20 to the lowered position.

The retaining mechanism 34 can be an electromechanical device that is operatively connected to a motion detector 44 positioned at any convenient location within the housing 12. The motion detector is positioned to detect when an animal has entered the housing 12 via a side opening 18 and send a signal to the retaining mechanism 34 (e.g., to an actuator of the retaining mechanism 34) to release the plunger member 20. Any of various known technologies can be used for the motion detector 44. For example, the motion detector can be an infrared detector, an ultrasonic detector, a microwave detector, or a tomographic detector.

The retaining mechanism 34 is configured to receive a signal from the motion detector 44 and produce movement of the piston 38 from the extended position to the retracted position. In particular embodiments, the retaining mechanism 34 can comprise, for example, an electromechanical solenoid that causes the piston to move relative to the housing when the solenoid is energized. In alternative embodiments, the retaining mechanism 34 can include an electric motor that moves the piston 38 or a similar component engaging the plunger member when a signal is received from the motion detector 44.

The animal trap 10 can further include one or more light sources 46 configured to illuminate the inside of the housing 12 and/or a subterranean burrow (e.g., a tunnel or hole) adjacent the housing 12. The one or more light sources 46 can be, for example, fixed to the inner surface of the housing 12. The light sources 46 can be, for example, LED's, incandescent bulbs, fluorescent bulbs, lasers, etc. Some animals, such as moles, are attracted to light in that if they sense light in a burrow, they will try to cover up or seal the hole through which the light enters the burrow. In this manner, the one or more light sources serve as bait or an attractant for the trap.

The trap 10 can also include a battery 48 for powering electronic components of the trap, such as the light source(s) 46, the motion detector 44, and the retaining mechanism 34. The battery can be of the rechargeable type or a non-rechargeable battery. In other embodiments, in lieu of or in addition to the battery 48, the trap 10 can include a power cord or an electrical receptacle that can be hard wired to electrical wiring that provides current to the electronic components of the trap 10.

FIG. 4 shows a method of using the animal trap 10 to trap an animal that primarily lives underground. As shown, a small hole is dug in the ground 50 above an animal burrow 52 (such as a mole tunnel). The housing 12 is placed within the ground such that the side openings 18 along the lower end portion of the housing are positioned within the burrow 52. FIG. 4 shows the top of the housing 12 as being somewhat level with the surface of the ground 50. However, it should be understood that the depth of the hole and the extent that the housing 12 is buried within the ground will depend on the depth of the burrow 52. In some embodiments, the trap can include a lid or cap at a top of the housing that prevents dirt from entering through the top of the housing if completely buried within the ground. The trap 10 optionally can include a flag 54 or similar visible marking device that is visible above ground when the housing is buried.

An animal inside the burrow (or tunnel) 52 can enter the housing 12 via one of the side openings 18. As discussed above, some animals, such as moles, are attracted to the light from the light source(s) 46. Upon entering the housing 12, the motion detector 44 can detect the presence of the animal and send a signal to the retaining mechanism 34. The retaining mechanism 34 receives the signal that an animal is in the housing moves the piston 38 to its retracted position, thereby releasing the plunger member 20. The plunger member 20 is then forced to the lowered position (shown in dashed lines in FIG. 4), allowing the lower end portion 26 of the plunger member to strike the animal. The animal can be incapacitated, killed or simply trapped without any physical harm, depending on the size and/or configuration of the lower end portion 26.

FIG. 6 shows another embodiment of the plunger member 20 having a lower end portion 60 comprising a base 62 and one or more spikes 64 extending downwardly from the base 62. The spikes 64 are configured to penetrate and kill the animal when the plunger member 20 is lowered to the lowered position.

FIG. 7 shows another embodiment of the plunger member 20 having a lower end portion 70 comprising a base 72 and a plurality of curved spikes or claws 74. Each claw 74 can be pivotably connected to the base 72 at an upper end 76 thereof so that the claws can pivot between a raised or radially expanded position in which their lower tips 78 are spaced farther apart from each other (shown in dashed lines) and a lowered or radially contracted position (shown in solid lines). The claws 74 can be spring-loaded and selectively retained in the raised position. When the plunger member 20 is released by the retaining mechanism 34 when an animal is detected, the claws can pivot toward each other to capture the animal between the claws 74. In some embodiments, the lower tips 78 are pointed and/or sharpened so as to penetrate and kill the animal when the claws are released and pivot toward each other.

In other embodiments, the lower tips 78 can be rounded or blunted to avoid penetrating the animal. Instead, the claws 74 can close around and trap the animal so that it can be removed from the trap and released at a different location.

In alternative embodiments, movement of the plunger member 20 between the raised and lowered positions can be achieved with an electromechanical device, in lieu of or in addition to use of the springs 28. For example, in one implementation, a small motor can be mounted inside the housing and can be operatively connected to the plunger member 20. The motor can be in communication with the motion detector 44 such that when an animal is detected, the motion detector sends a signal to the motor, which produces movement of the plunger member from the raised position to the lowered position. In another implementation, the plunger member 20 itself can be part of a solenoid device that is in communication with the motion detector 44. Upon receiving a signal from the motion detector that an animal is detected, the solenoid device is energized and moves the plunger member 20 from the raised position to the lowered position. Similarly, the plunger member 20 can be connected to the movable component of a solenoid device and can operate in the same way. It should be appreciated that the retaining mechanism 34 and the springs 28 would not be needed in embodiments utilizing motors, solenoids, or similar devices to produce movement of the plunger member.

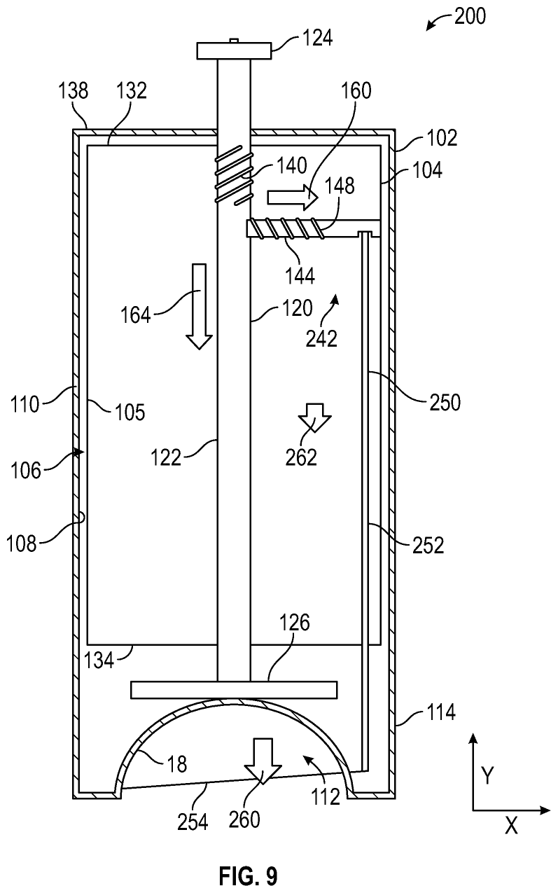

In alternative embodiments, in lieu of or in addition to the motion detector 44, the trap 10 can include a mechanical device in the lower portion of the housing 12 that can activate the plunger member 20 when an animal enters the housing. For example, a pressure plate or trip pan can be placed within the lower portion of the housing (e.g., as shown in FIG. 9, as described in further detail below). The pressure plate or trip pan can be coupled to a retaining bar or similar component that retains the plunger member 20 in the raised position against the bias of the spring 28. The animal's weight on the pressure plate or trip pan can move the retaining bar, allowing the plunger member 20 to be released to its lowered position. Alternatively, a moveable lever within the lower portion of the housing can be operatively connected to the plunger member such that movement of the lever upon contact with an animal can release the plunger member 20.

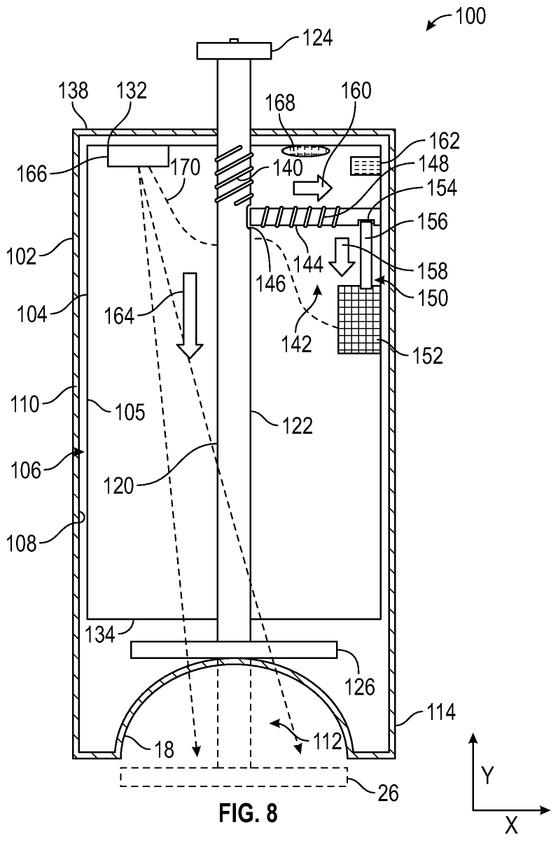

FIG. 8 shows another embodiment of an animal trap 100 which comprises an outer housing 102 and an inner cartridge 104 that is removably coupled to the housing 102 such that the inner cartridge 104 can be removed from an interior cavity 106 defined by an inner surface (or surfaces) 108 of walls 110 of the housing 102. In this way, the inner cartridge 104 is removably coupled to an interior (e.g., inner surfaces 108) of the housing 102 by a mating interface or connection, as described further below with reference to FIGS. 11 and 14.

The animal trap 100 can include similar components to those of the animal trap 10, as described above. Thus, similar components are labeled similarly in FIG. 8. For example, like the trap 10, the housing 102 of the trap 100 can include one or more side openings 18. In some embodiments, the trap 100 can include a single side opening 18. In other embodiments, the trap 100 can include multiple side openings 18 around a circumference of the housing 102. The one or more side openings 18 can provide access to an internal cavity 112 within a lower end portion 114 of the housing 102.

A perspective view of an exemplary embodiment of the housing 102 alone is shown in FIG. 14. In the view of FIG. 14, the side opening 18 is not visible. As shown in FIG. 14, the housing 102 can comprise a body 116 configured as a shell with a hollow interior forming the interior cavity 106. Thus, the housing 102 can also be referred to as an exterior or outer shell. In some embodiments, as shown in FIG. 14, the body 116 is cylindrical. In the illustrated embodiment, the outer housing 102 comprises a unitary, cylindrically shaped or tubular member. In other embodiments, the body 116 can have a different shape, such as that of a cuboid, rectangular prism, cube, or the like. In alternative embodiments, the outer housing 102 can have a two-piece construction like the housing 12 of FIGS. 1-3, permitting the two housing portions to be opened and closed to facilitate placing and removing the inner cartridge 104 into and from the outer housing.

In some embodiments, as shown in FIG. 14, the housing 102 can include a handle 118. For example, the handle 118 can be coupled to a top surface 138 or upper portion of the body 116 of the housing 102. The handle 118 is configured to be grasped (e.g., held) by a user and receive a portion of a plunger member 120 therethrough (as described further below). For example, the handle 118 can include a slot 117 shaped to receive a portion of the plunger member 120. In FIG. 14, the handle 118 is configured as a plate that extends across the top of the body 116. However, in other embodiments, the handle 118 can have a different shape, such as being curved or having a portion that extends outward from (e.g., above) the body 116.

In some embodiments, the handle 118 can be removable from the body 116 of the housing 102. In some embodiments, the handle 118 can be connected to the body 116 by a hinge that allows the handle 118 to be rotated or pivoted away from an opening 135 in an end of the body 116.

In some embodiments, instead of the handle 118 shown in FIG. 14, the housing 102 can include a cap that is configured to be coupled to the body 116 (e.g., at the opening 135). For example, the cap can be configured as a screw cap (with threads) that screws into mating threads on the inner surface 108 of the body 116 of the housing 102. In some embodiments, the cap can include a handle like handle 118. In this way, the cap may prevent debris (e.g., dirt) from falling into the trap when the cap is coupled to the body 116 of the housing 102 during use.

A perspective view of an exemplary embodiment of the cartridge 104, removed from the housing 102 and without any internal components mounted therein, is shown in FIG. 11. As shown in FIG. 11, the cartridge 104 can comprise sidewalls 130 extending between a first, upper support 132 and a second, lower support 134 of the cartridge 104. As used herein the “upper” support 132 and “lower” support 134 can be relative to the positioning of the cartridge 104 inside the housing 102. For example, as shown in FIG. 8, the upper support 132 can be arranged closer to the top surface 138 of the housing 102 than the lower support 134 and the lower support 134 can be arranged closer to the side opening 18 than the upper support 132, when the cartridge 104 is arranged within and coupled to the housing 102.

As shown in FIG. 11, the upper support 132 and lower support 134 can each include a central aperture (e.g., opening) 136 configured to receive a shaft portion 122 of the plunger member 120 therethrough (e.g., as shown in FIG. 8). The upper support 132 and lower support 134 can be configured to support and guide the plunger member 120 as it moves axially within the cartridge 104 and housing 102, similar to stabilizers 22 of the trap 10 (FIGS. 2-4). Thus, the upper support 132 and the lower support 134 can also be referred to herein as stabilizers.

In other embodiments, the cartridge 104 may only include one of the upper support 132 and lower support 134. In still other embodiments, the cartridge 104 can include one or more additional supports, disposed between the upper support 132 and lower support 134.

In some embodiments, the mating interface or connection (e.g., removable connection) between the housing 102 and cartridge 104 can include one or more grooves (or slots) 133 in the body 116 of the housing 102 and one or more extension portions (or elongate tabs) 131 that are configured to mate with one another. For example, as shown in FIG. 14, the housing 102 can include two grooves 133 extending from the top surface 138 and along a portion of a length of the housing 102. The grooves 133 can be depressed into the inner surface 108 of the housing 102. The cartridge 104 can include two complementary extension portions 131 that are configured to mate with respective grooves 133 (FIG. 11). As shown in FIG. 11, each extension portion 131 can extend radially outward from and along a length of a respective sidewall 130 of the cartridge 104.

During use, after creating a bore or hole in the ground to the target animal burrow with the housing 102, the handle 118 (or a cap) can be removed or pivoted out of the way of the opening 135 in the housing 102. The extension portions 131 can then be aligned with the corresponding grooves 133 and the extension portions 131 can be slid along the grooves 133 to insert the cartridge 104 into the housing 102. As a result, the cartridge 104 can be secured to the housing 102, but also later removed from the housing 102. Each groove 133 can include a ledge or end stop at its end inside the housing 102, thereby stopping the cartridge 104 from sliding further into the housing 102 and holding the cartridge 104 at a desired position (e.g., vertical position) within the housing 102.

In other embodiments, the mating interface or connection between the housing 102 and cartridge 104 can include more than two grooves 133 and extension portions 131 (e.g., three, four, or the like). In alternative embodiments, the grooves 133 can be formed on the cartridge 104 and the extension portions 131 can be formed on the housing 102.

In still other embodiments, the mating interface or connection between the housing 102 and cartridge 104 may be shaped or configured differently than shown in FIGS. 11 and 14. For example, in some embodiments, the mating interface or connection can comprise one or more tabs (on one of the cartridge 104 or housing 102) that are configured to snap into one or more openings or depressions (on the other one of the cartridge 104 or housing 102).

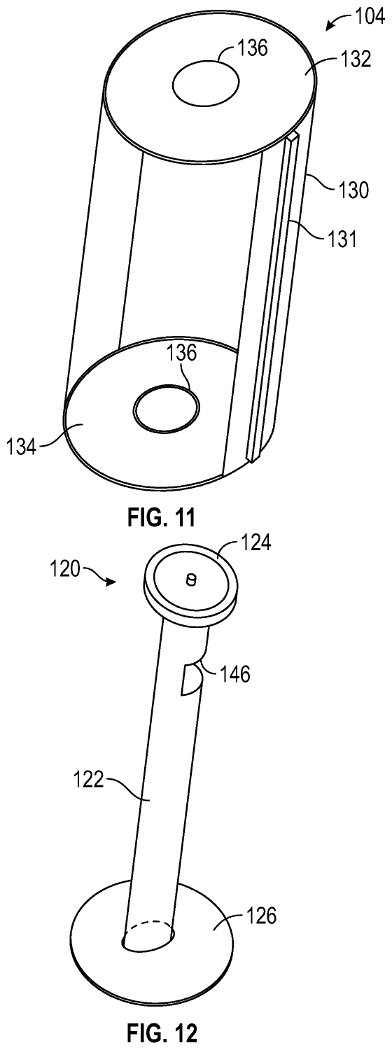

Returning to FIG. 8, the trap 100 can further comprise the plunger member 120, which can be similar to the plunger member 20 of trap 10 (FIGS. 2-4). The plunger member 120 can be supported by the cartridge 104 (as described above) and configured to move axially between a raised position and a lowered position relative to the housing 102 and the cartridge 104 (e.g., along the y-axis shown in FIG. 8). Thus, the plunger member 120 can be disposed at least partially within the housing 102 (e.g., when the cartridge 104 is disposed within the housing 102). A perspective view of an exemplary embodiment of the plunger member 120 is shown in FIG. 12.

As shown in FIGS. 8 and 12, the plunger member 120 can comprise a shaft portion (e.g., body or body portion) 122 and a lower end portion 126 disposed at the end of the shaft portion 122 (e.g., similar to or the same as the lower end portion 26 of trap 10, as shown in FIG. 4). The lower end portion 126 can be configured as a plate (as shown in FIGS. 8 and 12) or a member with spikes or claws for grasping an animal (e.g., such as the lower end portions shown in FIGS. 6 and 7). The shaft portion 122 can comprise a notch (e.g., indentation, recess, or depression) 146 (FIGS. 8 and 12) configured to receive a moveable piston of a retaining mechanism 142 of the trap 100, as described further below.

In some embodiments, the plunger member 120 can include handle portion 124 that is graspable by a user (FIGS. 8 and 12). The handle portion 124 can be disposed at a first, upper end of the shaft portion 122 while the lower end portion 126 can be disposed at a second, lower end of the shaft portion 122. In some embodiments, as shown in FIGS. 8 and 12, a diameter or width of the handle portion 124 is larger than a diameter or width of the shaft portion 122. While the handle portion 124 is depicted as circular in FIGS. 8 and 12, in other embodiments, the handle portion 124 can be square, rectangular, hexagonal, spherical, or the like.

When the plunger member 120 is arranged within the cartridge 104 and the housing 102, as shown in FIG. 8, the handle portion 124 can extend outside of the housing 102, above the top surface 138. As a result, when the trap 100 is disposed within the ground (as described above with reference to FIG. 4), the handle portion 124 can be visible and/or reachable by a user, thereby allowing a user to pull upward (e.g., in the positive y-direction in FIG. 8) and move the plunger member 120 into the raised position (as shown in solid lines in FIG. 8).

The trap 100 can further include a biasing element 140 that is configured to bias the plunger member 120 toward the lowered position (as shown by dashed lines in FIG. 8). In the illustrated embodiment, the biasing element 140 comprises a compression spring. For example, as depicted in FIG. 8, the biasing element 140 can be a compression spring disposed around and coupled to an upper portion of the shaft portion 122 of the plunger member 120. The biasing element 140 can be further coupled to and/or positioned against the upper support 132 of the cartridge 104. For example, the upper end of the spring 140 can bear against the upper inner surface of the support 132 and the lower end of the spring can be fixed to the shaft portion 122. The biasing element 140 of trap 100 can serve the same or a similar purpose as the spring(s) 28 of trap 10.

The trap 100 can further comprise a retaining mechanism 142. Similar to the retaining mechanism 34 of trap 10 (FIG. 4), the retaining mechanism 142 can include a moveable, first piston (e.g., slideable trigger member) 144 that is moveable between an extended position (shown in FIG. 8) and a retracted position (e.g., as shown in dashed lines in FIG. 5) in the direction of the x-axis. In the extended position, the first piston 144 engages the plunger member 120, such as the notch 146 of the plunger member 120, to retain the plunger member 120 in the raised position against the bias of the biasing element 140. When moved to the retracted position, the first piston 144 does not engage the plunger member 120, thereby allowing the plunger member 120 to move to the lowered position (shown in dashed lines in FIG. 8) under the force of the biasing element 140.

In some embodiments, the first piston 144 can be at least partially housed within and configured to retract into a housing (such as housing 36 shown in FIG. 4). In other embodiments, the first piston 144 can be configured to slide along a track that is part of and/or mounted to an inner surface 105 of the cartridge 104.

The retaining mechanism 142 can further include a biasing element 148 (e.g., a compression spring) that is configured to bias the first piston 144 toward or into the retracted position and an actuator (e.g., actuation member or element) 150 that is configured to selectively hold the first piston 144 in the extended position. For example, in the embodiment of FIG. 8, the actuator 150 is an electromechanical actuator. As one example, as shown in FIG. 8, the actuator 150 can include a solenoid 152 coupled to and configured to actuate a moveable, second piston 156. The second piston 156 can engage a notch 154 in the first piston 144 and be configured to move axially, in the direction of the y-axis, in response to actuation by the solenoid 152. In other embodiments, instead of a solenoid, the actuator 150 can include an electric motor coupled to the second piston 156 which is configured to actuate and move the second piston 156 out of engagement with the first piston 144.

The trap 100 can further include an energy storage device, such as a battery 162, mounted within the cartridge 104. The battery 162 can be configured to provide power to electronic components contained within the trap 100 and cartridge 104, such as the solenoid 152.

As an example, during use, the solenoid 152 can become energized and, as a result, move the second piston 156 downward and out of engagement with the first piston 144, as shown by arrow 158 (FIG. 8). In response to becoming disengaged from the second piston 156, and due to the biasing force of the biasing element 148, the first piston 144 moves, in the direction of arrow 160, into the retracted position. As a result, the plunger member 120 can move (e.g., under the biasing force of the biasing element 140), in the direction of arrow 164, into the lowered position (shown in dashed lines in FIG. 8), thereby trapping, incapacitating, or killing an animal that has entered the internal cavity 112.

In the embodiment of FIG. 8, and similar to the trap 10, the solenoid 152 of the actuator 150 can be in electronic communication (e.g., via direct electrical connection or wireless electronic communication) with a motion detector (e.g., sensor) 166, as indicated by dashed line 170. Similar to the motion detector 44 of trap 10, the motion detector 166 can be configured to detect when an animal has entered the internal cavity 112 and then send an electronic signal to the solenoid 152, which may result in energization of the solenoid 152 and actuation of the plunger member 120 into the lowered position, as described above. The motion detector 166 can be coupled to the inner surface 105 of the cartridge 104, anywhere in the cartridge 104 that allows the motion detector 166 to detect motion within the internal cavity 112, proximate to the side opening 18. Further, the motion detector 166 can be electrically coupled to and powered by the battery 162.

The trap 100 can further include one or more light sources 168 configured to illuminate the inside of the housing 102 (e.g., the internal cavity 112) and/or a subterranean burrow (e.g., a tunnel or hole) adjacent the lower end portion 114 of the housing 102 (FIG. 8). The one or more light sources 168 can be, for example, fixed to the inner surface 105 of the cartridge 104. The one or more light sources 168 can be configured similarly to the one or more light sources 46 of the trap 10, as described above with reference to FIG. 4.

The one or more light sources 168 can be powered by an internal battery or the battery 162.

As an example, during use of the trap 100 (and similar traps described herein, such as trap 200 described below with reference to FIG. 9), the outer housing 102 (without the inner cartridge 104 and the other internal components) can be used to bore out a hole (e.g., a vertical or angled hole) in the ground (e.g., ground 50 shown in FIG. 4) to the animal burrow (e.g., animal burrow 52 shown in FIG. 4), thereby creating access to the burrow. The cartridge 104 can then be inserted into and coupled with the housing 102, as shown in FIG. 8 (and FIG. 9), thereby forming the trap 100 (or 200 in FIG. 9). The trap can then be inserted into the bored-out hole such that the lower end portion 114 including the one or more side openings 18 is disposed within the animal burrow. An animal can then be caught or killed by the trap, as described above with reference to FIG. 4.

Turning now to FIG. 9, another embodiment of an animal trap 200 which comprises the outer housing 102 and the inner cartridge 104 that are removably coupled to one another is shown. The trap 200 can be similar to the trap 100 (FIG. 8), except it can include some different internal components arranged and mounted within the cartridge 104 that are configured to mechanically actuate the plunger member 120 of the trap 200. For example, instead of the electromechanical actuator 150 and associated components of trap 100, the trap 200 includes a retaining mechanism 242 comprising the first piston 144, the biasing element 148, and a mechanical actuator 250. Thus, the retaining mechanism 242 of the trap 200 can function similarly and have similar parts to the retaining mechanism 142 of the trap 100 (as described above with reference to FIG. 8), except the first piston 144 is actuated to slide from the extended position to the retracted position (as described above) via the actuator 250 which can be a mechanical actuator 250.

For example, as shown in FIG. 9, the actuator 250 can include a retaining rod (or bar) 252 and a trip pan or plate (or in alternate embodiments, a pressure plate) 254. As introduced above, the trip plate 254 can be placed within the lower end portion 114 of the housing 102. The trip plate 254 can be coupled to the retaining rod. Similar to the second piston 156 of the trap 100 (FIG. 8), the retaining rod 252 is configured to retain the first piston 144 is the extended position, thereby retaining the plunger member 120 in the raised position against the bias of the biasing element 140.

The animal's weight on the trip plate 254 (e.g., a pressure or force against the trip plate 254) can move the trip plate 254 downward, in the direction of arrow 260, thereby moving the retaining rod 252 downward, in the direction of arrow 262. Said another way, the trip plate 254 can be actuated in response to a downward force or pressure applied thereto (e.g., from an animal), thereby moving the retaining rod 252 downward and away from the first piston 144 (e.g., in the direction of the y-axis). As a result, the retaining rod 252 can disconnect (e.g., disengage) from the first piston 144, thereby allowing the first piston 144 to move into the retracted position, as shown by arrow 160, and disconnect from the plunger member 120. In response, the plunger member 120 is released and can lower, in the direction of arrow 164, into the lowered position (shown in dashed lines in FIG. 8).

In some embodiments, the trip plate 254 can be directly coupled to the retaining rod 252, without any intervening components therebetween. In other embodiments, the trip plate 254 can be coupled to the retaining rod 252 via one or more intervening mechanical connecting components (e.g., relatively rigid components that translate motion from the trip plate 254 to the retaining rod 252).

In this way, the trap 200 can be actuated mechanically, without input from any electrical components. Thus, the trap 200 may not need a battery or other means of electrical power within the trap 200.

In some embodiments, the trap 200 can include a light source, such as light source 168 of trap 100 (FIG. 8). The light source may include its own battery, or the trap 200 can include a battery for powering the light source (e.g., such as battery 162 shown in FIG. 8).

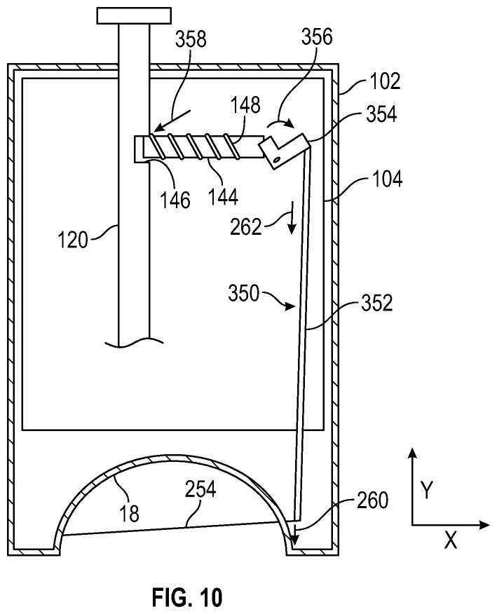

FIG. 10 shows another exemplary embodiment of a mechanical actuator 350 for a mechanical animal trap, such as the animal trap 200 of FIG. 9. For example, in some embodiments, the mechanical actuator 350 can replace the actuator 250 of the trap 200 of FIG. 9. The mechanical actuator 350 comprises the trip plate 254, a connecting rod 352 coupled to the trip plate 254, and a cam 354 coupled to the connecting rod 352. As shown in FIG. 10, the cam 354 can be in contact with and hold the first piston 144 in the extended position, when the connecting rod 352 and the trip plate 254 are in the raised position (e.g., not actuated or tripped). When an animal puts pressure on the trip plate 254, the trip plate 254 can move downward (shown by arrow 260), thereby moving the connecting rod 352 in the same direction (shown by arrow 262, which in turn rotates the cam 354, as shown by arrow 356. Rotation of the cam 354 causes the first piston 144 to move, in the x-direction, into the retracted position and out of engagement with the plunger member 120.

Less force (against the trip plate 254) may be required to rotate the cam 354 such that the first piston 144 can move out of engagement with the notch 146, thereby overcoming the resistance (indicated by arrow 358) between the first piston 144 and the notch 146, as compared to the action of pulling the retaining rod 252 out of the notch in the first piston 144 (FIG. 9). Thus, there may be less resistance to actuate the first piston 144 to move into the retracted position (and thus, allow the plunger member 120 to move into the lowered position), using the actuator 350 (FIG. 10) than the actuator 250 (FIG. 9).

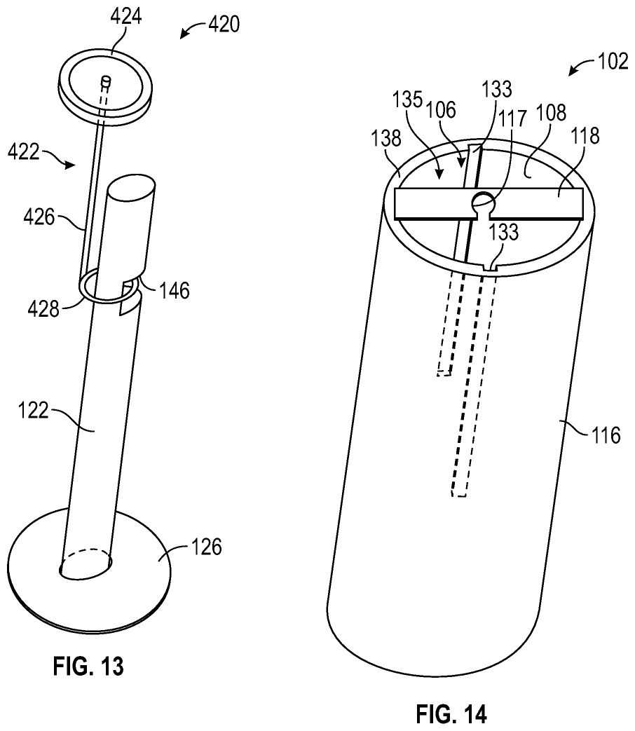

FIG. 13 is a perspective view of another exemplary embodiment of a plunger member 420, which is provided with a retractable or removable handle mechanism 422. The plunger member 420 can include similar components to those of plunger member 120, and thus these components are labeled similarly in FIG. 13. The retractable handle mechanism 422 can be configured to allow the plunger member 420 to be lifted into the raised position (e.g., via a user, external to the housing 102) and then to recede back into the cartridge 104 so that the retractable handle mechanism 422 does not extend out of the housing 102 (e.g., outward of and past the top surface 138 of the housing 102). When the animal trap is provided with such a retractable or removable handle mechanism 422, the plunger shaft 122 can be sized such that it is housed entirely within the inner cartridge 104 and the outer housing 102 when the plunger member is in its lowered and raised position. The handle mechanism 422 can be used to manipulate the plunger member from outside the housing 102 in order to set the trap, as further described below.

As shown in FIG. 13, the retractable handle mechanism 422 can include a handle portion 424 (which can be similar to the handle portion 124 of plunger member 120) and a shaft 426. The shaft 426 can either be removably coupled to the shaft portion 122 of the plunger member 420 and storable within an interior of the cartridge 104 or slideable along the shaft portion 122 such that the handle portion 424 can be moved (e.g., retracted) into the cartridge 104. In some embodiments, the removable or slideable connection between the shaft 426 and the shaft portion 122 can be formed by a coupling element 428 fixed to the lower end of the shaft 426. The coupling element 428 can be in the form of a ring, as shown in FIG. 13.

To set the trap, the coupling element 428 can be placed within the notch 146 of the plunger shaft 122 and then the user can pull upwards on the handle portion 424, which causes the plunger shaft 122 to move upwardly to its raised position. Once the plunger shaft 122 is secured in its raised position (such as by engagement of plunger 144), the coupling element 428 can be removed from the notch 146 and the handle mechanism 422 can be lowered into the inner cartridge 104 along the plunger shaft 122. In some embodiments, the handle mechanism 422 can be inserted completely into the inner cartridge 104 once the trap is set such that no portion of the handle mechanism extends above the housing 102 and the ground, thereby avoiding a potential tripping hazard. In other embodiments, after removing the coupling element 428 from the notch 146, the handle mechanism 422 can be lifted out of the housing 102 and completely removed from the trap.

In this way, an animal trap with an outer housing an inner cartridge that are removably coupled to one another can enable easy access into an animal burrow underneath the ground and more effective trapping or incapacitation of an animal within the burrow. Further, the same base components (e.g., the outer housing, inner cartridge, and plunger member) can be used with either mechanical or electromechanical actuation components of the trap, which can be mounted within the inner cartridge.

General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means physically coupled or linked and does not exclude the presence of intermediate elements between the coupled items absent specific contrary language.

### Additional Examples of the Disclosed Technology

In view of the above described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. An animal trap comprising: an outer housing configured as a hollow shell with one or more side openings in a lower end portion of the housing; a moveable plunger member; and an inner cartridge removably coupled to an interior of the housing, the cartridge supporting therein: the plunger member configured to move axially between a raised position and a lowered position relative to the housing and the cartridge; and a retaining mechanism configured to selectively retain the plunger member in the raised position.

Example 2. The animal trap of any example herein, particularly example 1, wherein the plunger member comprises a shaft portion with a biasing element configured to urge the plunger member into the lowered position and a lower end portion configured to incapacitate or kill an animal within an internal cavity of the lower end portion of the housing.

Example 3. The animal trap of any example herein, particularly example 2, wherein the retaining mechanism comprises a slideable piston moveable between a first position and a second position, wherein in the first position the piston engages the plunger members and holds it in the raised position, and wherein in the second position the piston is removed from engagement with the plunger member to allow the plunger member to move to the lowered position.

Example 4. The animal trap of any example herein, particularly example 3, wherein the retaining mechanism further comprises a mechanical actuator comprising a trip plate disposed in the lower end portion of the housing and a retaining rod coupled to the trip plate and configured to engage the piston and hold the piston in the first position and wherein the trip plate is configured to move the retaining rod out of engagement with the piston in response to pressure against the trip plate.

Example 5. The animal trap of any example herein, particularly example 3, wherein the retaining mechanism further comprises a mechanical actuator comprising a trip plate disposed in the lower end portion of the housing and a rod coupled to the trip plate and coupled to the piston via a cam, wherein the trip plate is configured to move the rod, which in turn moves the cam, wherein movement of the cam allows the piston to move from the first position to the second position.

Example 6. The animal trap of any example herein, particularly example 3, wherein the piston is a first piston and wherein the retaining mechanism further comprises an electromechanical actuator comprising a solenoid and a moveable, second piston that is configured to engage with the first piston and hold the first piston in the first position, the solenoid coupled to the second piston and configured to actuate the second piston to disengage from the first piston such that the first piston moves to the second position.

Example 7. The animal trap of any example herein, particularly example 6, further comprising a motion detector in electronic communication with the solenoid and configured to detect when an animal has entered the lower end portion of the housing and then send an electronic signal to the solenoid to energize the solenoid and actuate the plunger member into the lowered position.

Example 8. The animal trap of any example herein, particularly any one of examples 1-7, wherein the plunger member comprises a handle portion that is configured to be disposed exterior to the outer housing when the plunger member is in the raised position.

Example 9. The animal trap of any example herein, particularly any one of examples 1-7, further comprising a retractable or removable handle mechanism configured to engage the plunger member and permit a user to move the plunger member from the lowered position to the raised position.

Example 10. The animal trap of any example herein, particularly any one of examples 1-9, wherein the cartridge comprises sidewalls extending between an upper support and a lower support of the cartridge, the upper and lower supports each including a central aperture configured to receive a shaft portion of the plunger therethrough.

Example 11. An animal trap comprising: a housing comprising one or more side openings in a lower end portion thereof; a moveable plunger member disposed at least partially within the housing and configured to move between a raised position and a lowered position relative to the housing; a biasing element configured to resiliently urge the plunger member to the lowered position; a retaining mechanism configured to selectively retain the plunger member in the raised position against a biasing force of the biasing element; and a motion detector inside the housing and operatively connected to the retaining mechanism, wherein the motion detector is configured to detect the presence of an animal within the lower end portion of the housing and actuate the retaining mechanism to release the plunger member, thereby allowing the plunger member to move from the raised position to the lowered position under the biasing force.

Example 12. The animal trap of any example herein, particularly example 11, further comprising one or more light sources in the housing.

Example 13. The animal trap of any example herein, particularly any one of examples 11-12, wherein the housing comprises a tubular body and further comprising an inner cartridge removably coupled to the housing, wherein the retaining mechanism and plunger member are supported within the cartridge.

Example 14. The animal trap of any example herein, particularly example 13, wherein the cartridge comprises one or more stabilizers configured to support the plunger member for movement within the cartridge and the housing.

Example 15. The animal trap of any example herein, particularly any one of claims 11-14, wherein the retaining mechanism comprises a moveable piston that is moveable between a first position and a second position, wherein when the piston is in the first position, the piston blocks the plunger member from moving to the lowered position, and when the piston is in the second position, the piston is removed from blocking the plunger member from moving to the lowered position.

Example 16. The animal trap of any example herein, particularly any one of examples 11-15, wherein a lower end portion of the plunger member comprises a base and a plurality of claws pivotably connected to the base.

Example 17. The animal trap of any example herein, particularly any one of examples 11-16, wherein the housing comprises first and second housing portions that are pivotably coupled to each other with a hinge.

Example 18. The animal trap of any example herein, particularly example 17, wherein each housing portion comprises a semi-cylindrical body.

Example 19. An animal trap comprising: a housing comprising one or more side openings in a lower end portion thereof; a moveable plunger member disposed at least partially within the housing and configured to move between a raised position and a lowered position relative to the housing; one or more light sources disposed in the housing; and a motion detector inside the housing, wherein the motion detector is configured to detect the presence of an animal within the lower end portion of the housing and cause the plunger member to move from the raised position to the lowered position when an animal is detected within the lower end portion of the housing.

Example 20. The animal trap of any example herein, particularly example 19, further comprising: a biasing element configured to resiliently urge the plunger member to the lowered position; and a retaining mechanism configured to selectively retain the plunger member in the raised position against a biasing force of the biasing element.

Example 21. The animal trap of any example herein, particularly example 20, wherein the retaining mechanism comprises a moveable piston that is movable between a first position and a second position, wherein when the piston is in the first position, the piston blocks the plunger member from moving to the lowered position, and when the piston is in the second position, the piston is removed from blocking the plunger member from moving to the lowered position.

Example 22. The animal trap of any example herein, particularly any one of examples 19-21, further comprising one or more stabilizers mounted within the housing and configured to support the plunger member for movement within the housing.

Example 23. The animal trap of any example herein, particularly any one of examples 19-22, wherein the housing comprises first and second housing portions that are pivotably coupled to each other with a hinge.

Example 24. The animal trap of any example herein, particularly example 23, wherein each housing portion comprises a semi-cylindrical body.

Example 25. The animal trap of any example herein, particularly any one of examples 19-24, wherein a lower end portion of the plunger member comprising a base and a plurality of claws pivotably connected to the base.

Example 26. The animal trap of any example herein, particularly any one of examples 19-25, wherein the housing comprises a tubular body.

Example 27. A method of trapping an animal in the ground, the method comprising: placing an animal trap in the ground such a lower portion of a housing of the animal trap is disposed within an animal tunnel in the ground, wherein the animal trap comprising a plunger mechanism releasably retained in a raised position and a motion detector; wherein the motion detector detects the presence of animal within the lower portion of the housing and causes the plunger member to move from the raised position to a lowered position to capture or kill the animal within the housing.

Example 28. The method of any example herein, particularly example 27, further comprising activating a light source in the housing to illuminate the housing and the tunnel.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

1. An animal trap comprising:
an outer housing configured as a hollow shell with one or more side openings in a lower end portion of the housing;
a moveable plunger member; and
an inner cartridge removably coupled to an interior of the housing, the cartridge supporting therein:
the plunger member configured to move axially between a raised position and a lowered position relative to the housing and the cartridge; and
a retaining mechanism configured to selectively retain the plunger member in the raised position.

2. The animal trap of claim 1, wherein the plunger member comprises a shaft portion with a biasing element configured to urge the plunger member into the lowered position and a lower end portion configured to incapacitate or kill an animal within an internal cavity of the lower end portion of the housing.

3. The animal trap of claim 2, wherein the retaining mechanism comprises a slideable piston moveable between a first position and a second position, wherein in the first position the piston engages the plunger members and holds it in the raised position, and wherein in the second position the piston is removed from engagement with the plunger member to allow the plunger member to move to the lowered position.

4. The animal trap of claim 3, wherein the retaining mechanism further comprises a mechanical actuator comprising a trip plate disposed in the lower end portion of the housing and a retaining rod coupled to the trip plate and configured to engage the piston and hold the piston in the first position and wherein the trip plate is configured to move the retaining rod out of engagement with the piston in response to pressure against the trip plate.

5. The animal trap of claim 3, wherein the retaining mechanism further comprises a mechanical actuator comprising a trip plate disposed in the lower end portion of the housing and a rod coupled to the trip plate and coupled to the piston via a cam, wherein the trip plate is configured to move the rod, which in turn moves the cam, wherein movement of the cam allows the piston to move from the first position to the second position.

6. The animal trap of claim 3, wherein the piston is a first piston and wherein the retaining mechanism further comprises an electromechanical actuator comprising a solenoid and a moveable, second piston that is configured to engage with the first piston and hold the first piston in the first position, the solenoid coupled to the second piston and configured to actuate the second piston to disengage from the first piston such that the first piston moves to the second position.

7. The animal trap of claim 6, further comprising a motion detector in electronic communication with the solenoid and configured to detect when an animal has entered the lower end portion of the housing and then send an electronic signal to the solenoid to energize the solenoid and actuate the plunger member into the lowered position.

8. The animal trap of claim 1, wherein the plunger member comprises a handle portion that is configured to be disposed exterior to the outer housing when the plunger member is in the raised position.

9. The animal trap of claim 1, further comprising a retractable or removable handle mechanism configured to engage the plunger member and permit a user to move the plunger member from the lowered position to the raised position.

10. The animal trap of claim 1, wherein the cartridge comprises sidewalls extending between an upper support and a lower support of the cartridge, the upper and lower supports each including a central aperture configured to receive a shaft portion of the plunger therethrough.

11. An animal trap comprising:
a housing comprising one or more side openings in a lower end portion thereof;
a moveable plunger member disposed at least partially within the housing and configured to move between a raised position and a lowered position relative to the housing;
a biasing element configured to resiliently urge the plunger member to the lowered position;
a retaining mechanism configured to selectively retain the plunger member in the raised position against a biasing force of the biasing element; and
a motion detector inside the housing and operatively connected to the retaining mechanism, wherein the motion detector is configured to detect the presence of an animal within the lower end portion of the housing and actuate the retaining mechanism to release the plunger member, thereby allowing the plunger member to move from the raised position to the lowered position under the biasing force.

12. The animal trap of claim 11, further comprising one or more light sources in the housing.

13. The animal trap of claim 11, wherein the housing comprises a tubular body and further comprising an inner cartridge removably coupled to the housing, wherein the retaining mechanism and plunger member are supported within the cartridge.

14. The animal trap of claim 13, wherein the cartridge comprises one or more stabilizers configured to support the plunger member for movement within the cartridge and the housing.

15. The animal trap of claim 11, wherein the retaining mechanism comprises a moveable piston that is moveable between a first position and a second position, wherein when the piston is in the first position, the piston blocks the plunger member from moving to the lowered position, and when the piston is in the second position, the piston is removed from blocking the plunger member from moving to the lowered position.

16. The animal trap of claim 11, wherein a lower end portion of the plunger member comprises a base and a plurality of claws pivotably connected to the base.

17. An animal trap comprising:
a housing comprising one or more side openings in a lower end portion thereof;
a moveable plunger member disposed at least partially within the housing and configured to move between a raised position and a lowered position relative to the housing;
one or more light sources disposed in the housing; and
a motion detector inside the housing, wherein the motion detector is configured to detect the presence of an animal within the lower end portion of the housing and cause the plunger member to move from the raised position to the lowered position when an animal is detected within the lower end portion of the housing.

18. The animal trap of claim 17, further comprising:
a biasing element configured to resiliently urge the plunger member to the lowered position; and
a retaining mechanism configured to selectively retain the plunger member in the raised position against a biasing force of the biasing element.

19. The animal trap of claim 18, wherein the retaining mechanism comprises a moveable piston that is movable between a first position and a second position, wherein when the piston is in the first position, the piston blocks the plunger member from moving to the lowered position, and when the piston is in the second position, the piston is removed from blocking the plunger member from moving to the lowered position.

20. The animal trap of claim 17, further comprising one or more stabilizers mounted within the housing and configured to support the plunger member for movement within the housing.
